(19) United States
(12) Patent Application Publication
(10) Pub. No.: US 2017/0188104 A1
(43) Pub. Date: Jun. 29, 2017

(54) Information Pushing Method, Terminal and System for Electronic Program Guide Interface

(71) Applicant: SHENZHEN SKYWORTH-RGB ELECTRONIC CO., LTD., Shenzhen, Guangdong (CN)

(72) Inventors: Zhilong HOU, Shenzhen, Guangdong (CN); Yaoling XU, Shenzhen, Guangdong (CN)

(21) Appl. No.: 15/319,381

(22) PCT Filed: Sep. 9, 2015
(86) PCT No.: PCT/CN2015/089242

§ 371 Date: Dec. 16, 2016

(30) Foreign Application Priority Data
Jul. 1, 2015 (CN) 201510377421.0

(51) Int. Cl. H04N 21/472; G06Q 30/02; G06K 19/06; H04N 21/4722

(52) U.S. Cl. CPC H04N 21/472; H04N 21/4722; G06Q 30/0251; G06K 19/06037

(57) ABSTRACT

The present disclosure discloses an information pushing method for an electronic program guide interface which comprises that a terminal receives a program source comprising program information of each program and a preset bar code corresponding to each program, and the preset bar code loads business information related to each program; the electronic program guide interface is generated according to the program information and the corresponding preset bar code; and when an instruction to check the electronic program guide is received, the terminal displays the preset bar code corresponding to each program on the electronic program guide interface, so that a user can scan the preset bar code to obtain the business information related to each program. The present disclosure also discloses an information pushing terminal and an information pushing system for the electronic program guide interface.

### FIELD OF THE DISCLOSURE

The present disclosure relates to the field of digital television, and in particular, to an information pushing method, an information pushing terminal and an information pushing system for an electronic program guide interface.

### BACKGROUND OF THE DISCLOSURE

Currently, user normally acquires relevant information of programs by electronic program guide (Electronic Program Guide, EPG) interface, such as program content instruction, display time and so on. With the development of digitization, the content of digital television programs is more and more richer and the number of the digital television programs is more and more larger, user need to know more relevant information of programs. However, a display interface of a terminal is limited by size, the traditional electronic program guide interface can only provide limited program information, the electronic program guide interface cannot provide user much more relevant information of the programs, and cannot meet the requirement of user.

### SUMMARY OF THE DISCLOSURE

The present disclosure is to provide an information pushing method, an information pushing terminal and an information pushing system for electronic program guide interface, which aims to push user much more relevant information of programs through the electronic program guide interface.

In order to achieve the above aim, the present disclosure provides an information pushing method for an electronic program guide interface, which includes the following steps:

acquiring program information of each program included in a program source and a preset two-dimensional code corresponding to each program by a terminal, the preset two-dimensional code includes business information related to each program;

generating the electronic program guide interface according to each program included in the program information and the corresponding preset two-dimensional code; and

when receiving an instruction for checking the electronic program guide interface, displaying the preset two-dimensional code corresponding to each program included in the program information on the electronic program guide interface by the terminal, so that a user scanning the preset two-dimensional code to acquire the business information related to each program included in the program information.

Preferably, the terminal acquiring program information of each program and a preset two-dimensional code corresponding to each program included in a program source, the preset two-dimensional code including business information related to each program includes the following steps:

receiving a program transport stream sent by a program server by the terminal, the program transport stream comprises program information generated by the program server according to each program comprised in the program source, the preset two-dimensional code and relevant information recording a relationship between the program information and the preset two-dimensional codes, the preset two-dimensional codes comprises the business information related to each program;

analysing the program transport stream by the terminal to acquire the program information, the preset two-dimensional code and the relevant information, and acquiring the preset two-dimensional code corresponding to each program comprised in the program information according to the relevant information.

Preferably, displaying the preset two-dimensional code corresponding to each program included in the program information on the electronic program guide interface by the terminal when receiving the instruction for checking the electronic program guide interface, so that the user scans the preset two-dimensional codes to acquire the business information related to each program included in the program information, includes the following steps:

when receiving the instruction for checking the electronic program guide interface, displaying the preset two-dimensional code corresponding to each program comprised in the program information by the generated electronic program guide interface; or when receiving the instruction for checking the electronic program guide interface, displaying the preset two-dimensional code corresponding to each program comprised in the program information by a basic electronic program guide interface generated according to the program information.

Preferably, the business information includes a service content related to each program included in the program information and/or a chained address corresponding to the service content, after the terminal displaying the preset two-dimensional code corresponding to each program included in the program information on the electronic program guide interface when receiving the instruction for checking the electronic program guide interface, so that the user scanning the preset two-dimensional codes to acquire the business information related to each program included in the program information, the method further includes the following steps:

analysing the preset two-dimensional code by the terminal to acquire the business information in the preset two-dimensional code related to each program;

if the business information comprised in the preset two-dimensional code related to each program is the service content, displaying the service content on the terminal;

if the business information comprised in the preset two-dimensional code related to each program is the chained address corresponding to the service content, acquiring corresponding service content through the chained address on a service server by the terminal, and displaying the service content on the terminal.

Preferably, displaying the preset two-dimensional code corresponding to each program included in the program information on the electronic program guide interface by the terminal when receiving the instruction for checking the electronic program guide interface, so that the user scanning the preset two-dimensional code to acquire the business information related to each program included in the program information, includes the following steps:

when receiving the instruction for checking the electronic program guide interface, displaying the preset two-dimensional code corresponding to each program on a preset area of the electrical program menu interface by the terminal, so that the user scanning the preset two-dimensional code to acquire the business information related to each program comprised in the program information.

In addition, in order to achieve the aim, the present disclosure also provides an information pushing terminal for an electronic program guide interface, which includes:

an acquiring module, the acquiring module is used for acquiring program information of each program included in a program source and a preset two-dimensional code corresponding to each program, and the preset two-dimensional code includes business information related to each program;

a generating module, the generating module is used for generating the electronic program guide interface according to each program included in the program information and the corresponding preset two-dimensional code;

a displaying module, the displaying module is used for displaying the preset two-dimensional code corresponding to each program included in the program information on the electronic program guide interface when receiving an instruction for checking the electronic program guide interface, so that a user scans the preset two-dimensional code to acquire the business information related to each program included in the program information.

Preferably, the acquiring module is also used for receiving a program transport stream sent by a program server, the program transport stream includes program information generated by the program server according to each program included in the program source, the preset two-dimensional code and relevant information recording a relationship between each program and the preset two-dimensional code, the preset two-dimensional codes includes the business information related to each program; the acquiring module is also used for analyzing the program transport stream to acquire the program information, the preset two-dimensional code and the relevant information, and acquire each program included in the program information and corresponding preset two-dimensional code according to the relevant information.

Preferably, the displaying module is also used for displaying the preset two-dimensional code corresponding to each program included in the program information on the generated electric program interface when receiving the instruction for checking the electronic program guide interface; or when the instruction for checking the electronic program guide interface is received, the displaying module is also used for displaying the preset two-dimensional code corresponding to each program included in the program information on a basic electronic program guide interface generated according to the program information.

Preferably, the business information includes a service content related to each program included in the program information and/or a chained address corresponding to the service content, terminal further includes:

an analyzing module, the analyzing module is used for analyzing the preset two-dimensional codes to acquire the business information in the preset two-dimensional codes related to each program; if the business information included in the preset two-dimensional codes related to each program is the service content, the service content is displayed on the terminal; if the business information included in the preset two-dimensional codes related to each program is the chained address corresponding to the service content, the analyzing module acquires corresponding service content by the chained address on the service server, and the service content is displayed on the terminal

Preferably, the displaying module is also used for displaying the preset two-dimensional code corresponding to each program on a preset area of the electrical program menu interface when receiving the instruction for checking the electronic program guide interface, so that the user scans the preset two-dimensional codes to acquire the business information related to each program included in the program information.

The present disclosure also provides an information pushing system for an electronic program guide interface, which includes a terminal and a program server, and,

the program server generates program information and preset bar cod according to each program included in a program source, the preset two-dimensional code includes business information related to each program; the program information included in the program source and the preset two-dimensional code are sent to the terminal;

the terminal acquires the program information of each program included in the program source and the preset two-dimensional code corresponding to each program; the electronic program guide interface is generated according to each program included in the program information and the corresponding preset two-dimensional code; when receiving an instruction for checking the electronic program guide interface, the electronic program guide interface displays the preset two-dimensional code corresponding to each program included in the program information, so that a user scans the preset two-dimensional code to acquire business information related to each program included in the program information.

The present disclosure provides the information pushing method, the information pushing terminal and the information pushing system for the electronic program guide interface, the program information of each program and the preset two-dimensional code including business information corresponding to each program are displayed on the electronic program guide interface, so that user can acquire the business information related with each program by scanning the preset two-dimensional code, pushing relevant business information to user on the electronic program guide interface by two-dimensional code is achieved, the abundance of business information can be pushed to user on the electronic program guide interface through the two-dimensional codes, the requirement of acquiring much more business information related to the programs is met.

### BRIEF DESCRIPTION OF THE DRAWINGS

FIG. 1 is a flow diagram of an information pushing method for the electronic program guide interface according to a first exemplary embodiment;

FIG. 2 is a flow diagram of an information pushing method for the electronic program guide interface according to a second exemplary embodiment;

FIG. 3 is a function module diagram of an information pushing terminal for the electronic program guide interface according to a first exemplary embodiment;

FIG. 4 is a function module diagram of an information pushing terminal for the electronic program guide interface according to a second exemplary embodiment;

FIG. 5 is a structure diagram of an information pushing system for the electronic program guide interface according to an exemplary embodiment.

The realizing of the aim, functional characteristics, advantages of the present disclosure are further described in detail with reference to the accompanying drawings and the embodiments.

### DETAILED DESCRIPTION OF THE EMBODIMENTS

It is to be understood that, the described embodiments are only some exemplary embodiments of the present disclosure, and the present disclosure is not limited to such embodiments.

Therefore, the present disclosure provides an information pushing method for an electronic program guide interface.

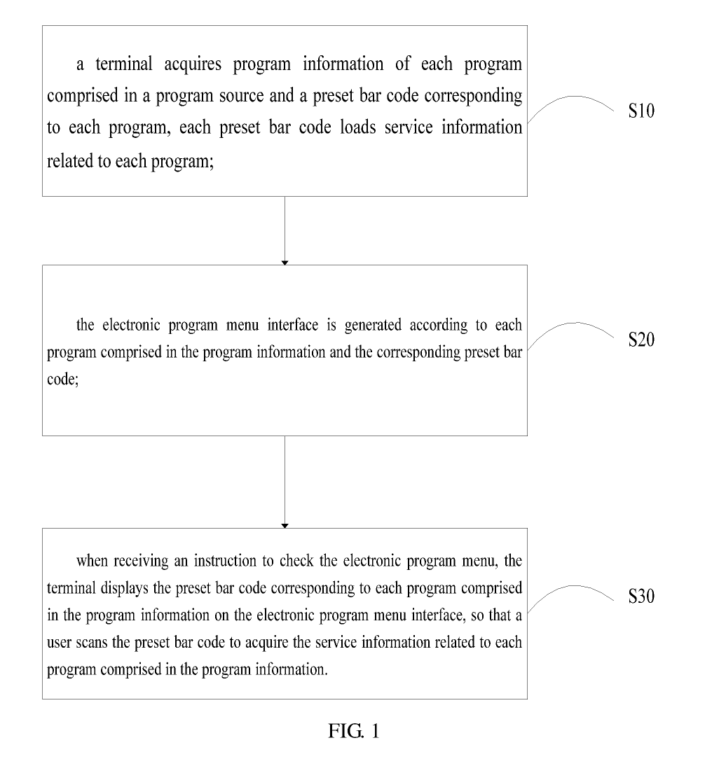

Referring to FIG. 1, FIG. 1 is a flow diagram of an information pushing method for the electronic program guide interface according to a first exemplary embodiment.

In a first exemplary embodiment, the information pushing method for the electronic program guide interface includes the following steps:

Step S10, acquiring program information of each program included in a program source and a preset two-dimensional code corresponding to each program by a terminal, each preset two-dimensional code includes business information related to each program;

In the exemplary embodiment, first, the terminal acquires program information of each program included in a program source and a preset two-dimensional code corresponding to each program, and, the program information can be basic information, such as a name of each program, a classify of each program, and so on, the preset two-dimensional code includes business information related to each program included in the program information, such as a brief introduction of program content, and a playing time and so on. The preset two-dimensional code can be generated by the terminal itself according to business information related to each program included in the program information, can also be generated by other device, such as program server, rather than the terminal, according to each program and the business information related to each program when preparing a program source, the terminal only need to acquire program information including each program and corresponding preset two-dimensional code from the program source sent from the program server.

Step S20, generating the electronic program guide interface according to each program included in the program information and the corresponding preset two-dimensional code;

Step S30, when an instruction for checking the electronic program guide interface is received, displaying the preset two-dimensional code corresponding to each program included in the program information on the electronic program guide interface by the terminal, so that user scans the preset two-dimensional code to acquire the business information related to each program included in the program information.

when the terminal receives the instruction inputted by user to check the electronic program guide interface, the electronic program guide interface is displayed, at the same time, the preset two-dimensional code related to each program included in the program information is also displayed on the electronic program guide interface. Therefore, user only need to scan the preset two-dimensional code displayed on the electronic program guide interface to acquire the business information related to corresponding program, so that pushing business information related to program on the electronic program guide interface to user is realized. As the two-dimensional code can include large amount of information, and preset in a form of simple image, pushing relevant information of program by the two-dimensional code on the electronic program guide interface can not only easily provide user large amount of information included in the two-dimensional code, but also make the electronic program guide interface to be simple and elegant.

The exemplary embodiment displays the program information of each program and the preset two-dimensional code including the business information related to each program on the electronic program guide interface, so that user can only need to scan the preset two-dimensional code to acquire the business information related to each program, pushing the business information related to the program by the two-dimensional code on the electronic program guide interface is realized, rich and large amount of business information can be pushed to user through the two-dimensional code on the electronic program guide interface, user's requirement of acquiring much more relevant business information is met.

Furthermore, in another exemplary embodiment, the step S10 can also include:

Receiving a program transport stream sent by a program server by the terminal, the program transport stream includes program information generated by the program server according to each program included in the program source, the preset two-dimensional codes and relevant information recording of a relationship between each program and the preset two-dimensional code, the preset two-dimensional codes includes the business information related to each program;

Analysing the program transport stream by the terminal to acquire the program information, the preset two-dimensional codes and the relevant information, and acquiring a preset two-dimensional code corresponding to each program included in the program information according to the relevant information.

In the exemplary embodiment, first, program server deals with the program included in the program source, basic information, such as program information including names of the programs, the preset two-dimensional codes, and relevant information, can be generated according to program data included in the program source, and the preset two-dimensional code can be generated by the program server according to the business information related to each program in the program information acquired by a service server, that is, the preset two-dimensional codes include the business information related to each program included in the program information acquired by the program server from the service server. It is to be noted that, in the exemplary embodiment, the preset two-dimensional codes can be service content related to each program included in the program information, can also be chained address corresponding to the service content; if the business information included in the reset two-dimensional code is information stored in the program server itself, the program server can be regarded as the service server, that is, the preset two-dimensional code can be generated by the program server according to the business information stored by the program server itself and related to each program included in the program information; the relevant information records a relationship between each program included in the program information and the preset two-dimensional code, so that different programs and corresponding preset two-dimensional codes can form corresponding relationship. The program server can package, multiplex each program data, program information, the preset two-dimensional code, to generate the program transport stream, and send the generated program transport stream to the terminal.

After the terminal receives the program transport stream sent by the program server, the terminal can demultiplex the program transport stream to acquire each program data, program information, the preset two-dimensional code and relevant information, the terminal can directly display programs according to the program data, acquire each program included in the program information in the program source and corresponding preset two-dimensional code according to the relevant information. It is to be noted that, in the exemplary embodiment, the relationship between each program in the program information and one preset two-dimensional code can be one to one, such as each program correspond to one preset two-dimensional code; the relationship between each program in the program information and one preset two-dimensional code is not one to one, such as when the business information related to a plurality of programs is different, the plurality of programs can correspond to one preset two-dimensional code.

In the exemplary embodiment, as the operations, such as generating the program information according to the program included in the program source, the preset two-dimensional code, and so on, are operated in the program server, the terminal only needs to demultiplex the program transport stream sent by the program server, to acquire the program information, the preset two-dimensional code and so on, as system resources occupied a little area of the terminal, and when the program server transmits the program source to the terminal, the terminal only needs to add information with little data amount, such as generated program information, the preset two-dimensional code and so on, the program server occupies little network resource, it is much more conducive to data transmit between the program server and the terminal.

Furthermore, when the terminal receives an instruction for checking the electronic program guide interface, the terminal displays the program information and the preset two-dimensional code, in detail, in an exemplary embodiment, when the terminal receives an instruction for checking the electronic program guide interface, the preset two-dimensional code corresponding to each program included in the program information is displayed on the basic electronic program guide interface generated according to the program information, and the basic electronic program guide interface can be generated according to each program included in the program information, the basic electronic program guide interface only includes basic information of each program, such as, name, and so on; in another exemplary embodiment, the preset two-dimensional code corresponding to each program included in the program information can be received in the basic electronic program guide interface generated according to the program information, to form the electronic program guide interface first, when the terminal receives an instruction for checking the electronic program guide interface, the generated electronic program guide interface can be directly used. In addition, when the electronic program guide interface displays each program included in the program information and the preset two-dimensional code, positions of each program included in the program information and the preset two-dimensional code can be arranged, each program included in the program information and the preset two-dimensional code can be adjusted to be images suit for being displayed on the electronic program guide interface, and, the adjusted each program included in the program information and the preset two-dimensional code can be displayed on a preset area on the electronic program guide interface, such as a corner, or an edge area, to save a displaying room of the electronic program guide interface.

After each program included in the program information and corresponding preset two-dimensional code are displayed on the electronic program guide interface, user can scans the preset two-dimensional code to acquire the business information related to each program included in the program information, if the acquired business information is the service content, the service content is displayed on the terminal; if the acquired business information is the chained address corresponding to the service content, the terminal searches service content corresponding to the chained address on the service server according to chained address, and the service content is displayed on the terminal.

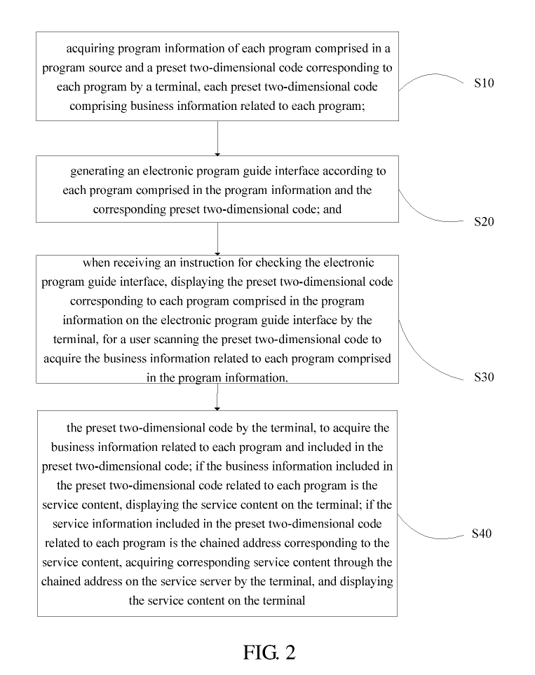

Referring to FIG. 2, a second exemplary embodiment of the present disclosure provides an information pushing method for an electronic program guide interface, based on the first exemplary embodiment, after step S30, the method according to the second exemplary embodiment further includes:

Step S40, analysing the preset two-dimensional code by the terminal, to acquire the business information related to each program and included in the preset two-dimensional code; if the business information included in the preset two-dimensional code related to each program is the service content, displaying the service content on the terminal; if the business information included in the preset two-dimensional code related to each program is the chained address corresponding to the service content, acquiring corresponding service content by the chained address on the service server by the terminal, and displaying the service content on the terminal.

In the exemplary embodiment, after the electronic program guide interface displays each program included in the program information and corresponding preset two-dimensional code, the terminal can also analyses the preset two-dimensional code displayed on the electronic program guide interface to acquire the business information included in the preset two-dimensional code and related to each program included in the program information; if the analysed business information included in the preset two-dimensional code and related to each program included in the program information is service content, the terminal directly displays the service content; if the analysed business information included in the preset two-dimensional code and related to each program included in the program information is chained address corresponding to the service content, corresponding service content is searched and acquired through the chained address on the service server, and the service content is displayed on the terminal. So that the business information included in the preset two-dimensional code and related to the program information can be displayed to user through the terminal.

In additional, after user scans and analyses the preset two-dimensional code, if the analysed business information included in the preset two-dimensional code and related to each program included in the program information is chained address corresponding to the service content, a user device can send a request to the service server according to the chained address corresponding to the service content, while, the user device does not directly acquire the service content corresponding chained address, but the service server can send the service content corresponding to the chained address to the terminal according to the request sent by the user device, and the terminal displays the service content corresponding to the chained address, so that user can easily check the service content on the terminal with better displaying effective.

The present disclosure also provides an information pushing terminal for an electronic program guide interface.

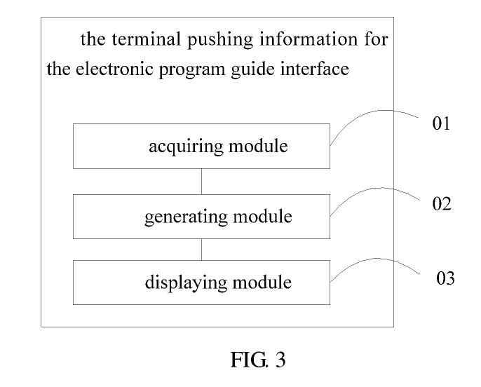

Referring to FIG. 3, FIG.3 is a function module diagram of an information pushing terminal for the electronic program guide interface according to a first exemplary embodiment.

In a first exemplary embodiment, the information pushing terminal for an electronic program guide interface includes:

an acquiring module 01, the acquiring module 01 is used for acquiring program information having each program in program source and a preset two-dimensional code corresponding to each program, and the preset two-dimensional code includes business information related to each program;

In the exemplary embodiment, first, the terminal acquires the program information of each program included in the program source and the preset two-dimensional code corresponding to each program, and the program information include basic information, such as a name of each program, a classify of each program and so on, the preset two-dimensional code includes business information related to each program included in the program information, such as a brief introduction of program content, and a playing time and so on. The preset two-dimensional code can be generated by the terminal itself according to business information related to each program included in the program information, can also be generated by other device, such as program server, rather than the terminal, according to each program and the business information related to each program when preparing a program source, the terminal only need to acquire program information including each program and corresponding preset two-dimensional code from the program source sent from the program server.

a generating module 02, the generating module 02 is used for generating the electronic program guide interface according to each program included in the program information and the corresponding preset two-dimensional code;

a displaying module 03, the displaying module 03 is used for displaying the preset two-dimensional code corresponding to each program included in the program information on the electronic program guide interface when receiving an instruction for checking the electronic program guide interface, so that a user scans the preset two-dimensional code to acquire the business information related to each program included in the program information.

when the terminal receives the instruction inputted by user to check the electronic program guide interface, the electronic program guide interface is displayed, at the same time, the preset two-dimensional code related to each program included in the program information is also displayed on the electronic program guide interface. Therefore, user only need to scan the preset two-dimensional code displayed on the electronic program guide interface to acquire the business information related to corresponding program, so that pushing business information related to program on the electronic program guide interface to user is realized. As the two-dimensional code can include large amount of information, and preset in a form of simple image, pushing relevant information of program by the two-dimensional code on the electronic program guide interface can not only easily provide user large amount of information included in the two-dimensional code, but also make the electronic program guide interface to be simple and elegant.

The exemplary embodiment displays the program information of each program and the preset two-dimensional code including the business information related to each program on the electronic program guide interface, so that user can only need to scan the preset two-dimensional code to acquire the business information related to each program, pushing the business information related to the program by the two-dimensional code on the electronic program guide interface is realized, rich and large amount of business information can be pushed to user through the two-dimensional code on the electronic program guide interface, user's requirement of acquiring much more relevant business information is met.

Furthermore, in other exemplary embodiment, the acquiring module 01 can also be used for:

A program transport stream sent by a program server is received, the program transport stream includes program information generated by the program server according to each program included in the program source, the preset two-dimensional codes and relevant information recording a relationship between each program and the preset two-dimensional code, the preset two-dimensional codes includes the business information related to each program; the program transport stream is analysed to acquire the program information, the preset two-dimensional codes and the relevant information, and a preset two-dimensional code corresponding to each program included in the program information is acquired according to the relevant information.

In the exemplary embodiment, first, the program server deals with the program included in the program source, basic information, such as program information including names of the programs, the preset two-dimensional codes, and relevant information, can be generated according to program data included in the program source, and the preset two-dimensional code can be generated by the program server according to the business information related to each program in the program information acquired by a service server, that is, the preset two-dimensional codes include the business information related to each program included in the program information acquired by the program server from the service server. It is to be noted that, in the exemplary embodiment, the business information included in the preset two-dimensional codes can be service content related to each program included in the program information, can also be chained address corresponding to the service content; if the business information included in the reset two-dimensional code is information stored in the program server itself, the program server can be regarded as the service server, that is, the preset two-dimensional code can be generated by the program server according to the business information stored by the program server itself and related to each program included in the program information; the relevant information records a relationship between each program included in the program information and the preset two-dimensional code, so that different programs and corresponding preset two-dimensional codes can form corresponding relationship. The program server can package, multiplex each program data, program information, the preset two-dimensional code, to generate the program transport stream, and send the generated program transport stream to the terminal.

After the terminal receives the program transport stream sent by the program server, the terminal can demultiplex the program transport stream to acquire each program data, program information, the preset two-dimensional code and relevant information, the terminal can directly display programs according to the program data, acquire each program of the program information in the program source and corresponding preset two-dimensional code according to the relevant information. It is to be noted that, in the exemplary embodiment, the relationship between each program in the program information and one preset two-dimensional code can be one to one, such as each program correspond to one preset two-dimensional code; the relationship between each program in the program information and one preset two-dimensional code is not one to one, such as when the business information related to a plurality of programs is different, the plurality of programs can correspond to one preset two-dimensional code.

In the exemplary embodiment, as the operations, such as generating the program information according to the program included in the program source, the preset two-dimensional code, and so on, are operated in the program server, the terminal only needs to demultiplex the program transport stream sent by the program server, to acquire the program information, the preset two-dimensional code and so on, only a little of system resources of the terminal is occupied, and when the program server transmits the program source to the terminal, the terminal only needs to add information with little data amount, such as generated program information, the preset two-dimensional code and so on, the program server occupies little network resource, it is much more conducive to data transmit between the program server and the terminal.

Furthermore, when the terminal receives an instruction for checking the electronic program guide interface, the terminal displays the program information and the preset two-dimensional code, in detail, in an exemplary embodiment, when the terminal receives an instruction for checking the electronic program guide interface, the preset two-dimensional code corresponding to each program included in the program information is displayed on the basic electronic program guide interface generated according to the program information, and the basic electronic program guide interface can be generated according to each program included in the program information, the basic electronic program guide interface only includes basic information of each program, such as, name, and so on; in another exemplary embodiment, the preset two-dimensional code corresponding to each program included in the program information can be received in the basic electronic program guide interface generated according to the program information, to form the electronic program guide interface first, when the terminal receives an instruction for checking the electronic program guide interface, the generated electronic program guide interface can be directly used. In addition, when the electronic program guide interface displays each program included in the program information and the preset two-dimensional code, positions of each program included in the program information and the preset two-dimensional code can be arranged, each program included in the program information and the preset two-dimensional code can be adjusted to be images suit for being displayed on the electronic program guide interface, and, the adjusted each program included in the program information and the preset two-dimensional code can be displayed on a preset area on the electronic program guide interface, such as a corner, or an edge area, to save a displaying room of the electronic program guide interface.

After each program included in the program information and corresponding preset two-dimensional code are displayed on the electronic program guide interface, user can scans the preset two-dimensional code to acquire the business information related to each program included in the program information, if the acquired business information is the service content, the service content is displayed on the terminal; if the acquired business information is the chained address corresponding to the service content, the terminal searches service content corresponding to the chained address on the service server according to chained address, and the service content is displayed on the terminal.

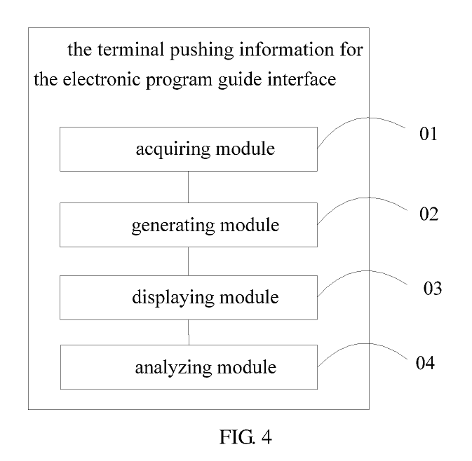

Referring to FIG. 4, the present disclosure also provides an information pushing terminal for an electronic program guide interface according to a second exemplary embodiment, based on the first exemplary embodiment, the information pushing terminal according to the second exemplary embodiment further includes:

an analyzing module 04, the analyzing module 04 is used for analyzing the preset two-dimensional codes to acquire the business information in the preset two-dimensional codes related to each program; if the business information included in the preset two-dimensional codes related to each program is the service content, the service content is displayed on the terminal; if the business information included in the preset two-dimensional codes related to each program is the chained address corresponding to the service content, the analyzing module acquires corresponding service content by the chained address on the service server, and the service content is displayed on the terminal.

In the exemplary embodiment, after the electronic program guide interface displays the preset two-dimensional code corresponding to each program included in the program information, the terminal can also analyses the preset two-dimensional code displayed on the electronic program guide interface to acquire the business information included in the preset two-dimensional code and related to each program included in the program information; if the analysed business information included in the preset two-dimensional code and related to each program included in the program information is service content, the terminal directly displays the service content; if the analysed business information included in the preset two-dimensional code and related to each program included in the program information is chained address corresponding to the service content, corresponding service content is searched and acquired through the chained address on the service server, and the service content is displayed on the terminal. So that the business information included in the preset two-dimensional code and related to the program information can be displayed to user through the terminal.

In additional, after user scans and analyses the preset two-dimensional code, if the analysed business information included in the preset two-dimensional code and related to each program included in the program information is chained address corresponding to the service content, a user device can send a request to the service server according to the chained address corresponding to the service content, while, the user device does not directly acquire the service content corresponding chained address, but the service server can send the service content corresponding to the chained address to the terminal according to the request sent by the user device, and the terminal displays the service content corresponding to the chained address, so that user can easily check the service content on the terminal with better displaying effective.

The present disclosure also provides an information pushing system for an electronic program guide interface.

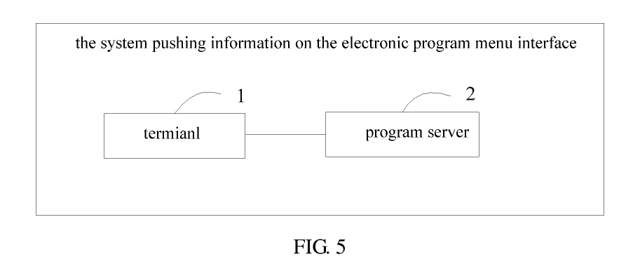

Referring to FIG. 5, FIG. 5 is a structure diagram of an information pushing system for the electronic program guide interface according to an exemplary embodiment.

In an exemplary embodiment, the information pushing system includes: a terminal 1 and a program server 2, and the program server 2 generates program information and preset two-dimensional codes according to each program included in a program source; the program server 2 sends the program information in the program source and the preset two-dimensional codes to the terminal 1;

the terminal 1 acquires the program information of each program included in the program source and the preset two-dimensional code corresponding to each program; the electronic program guide interface is generated according to each program included in the program information and the corresponding preset two-dimensional code; when receiving an instruction for checking the electronic program guide interface, the electronic program guide interface displays the preset two-dimensional code corresponding to each program included in the program information, so that user scans the preset two-dimensional code to acquire business information related to each program in the program information.

In the exemplary embodiment, first, the program server 2 deals with the program in the program source, and generates basic information according to program data in the program source, the basic information can be the program information having program name, the preset two-dimensional code, and relevant information, and the preset two-dimensional code can be generated by the program server according to the business information related to each program in the program information acquired by service server, that is, the preset two-dimensional codes include the business information related to each program included in the program information acquired by the program server 2 from the service server. It is to be noted that, in the exemplary embodiment, the business information included in the preset two-dimensional code can be service content related to each program included in the program information, can also be chained address corresponding to the service content; if the business information included in the reset two-dimensional code is information stored in the program server 2 itself, the program server 2 can be regarded as the service server, that is, the preset two-dimensional code can be generated by the program server 2 according to the business information stored by the program server 2 itself and related to each program included in the program information; the relevant information records a relationship between each program included in the program information and the preset two-dimensional code, so that different programs and corresponding preset two-dimensional codes can form corresponding relationship. The program server can package, multiplex each program data, program information, the preset two-dimensional code, to generate the program transport stream, and send the generated program transport stream to the terminal.

After the terminal 1 receives the program transport stream sent by the program server 2, the terminal 1 can demultiplex the program transport stream to acquire each program data, program information, the preset two-dimensional code and relevant information, the terminal 1 can directly display programs according to the program data, acquire each program included in the program information in the program source and corresponding preset two-dimensional code according to the relevant information. In detail, when the terminal 1 receives the instruction for checking the electronic program guide interface, the process of displaying the preset two-dimensional code corresponding to each program included in the program information on the electronic program guide interface by the terminal 1, so that user can scan the preset two-dimensional code to acquire the business information related to each program in the program information, is the same as described above, no need to repeat again.

In the exemplary embodiment, as the operations, such as generating the program information according to the program included in the program source, the preset two-dimensional code, and so on, are operated in the program server 2, the terminal 1 only needs to demultiplex the program transport stream sent by the program server 2, to acquire the program information, the preset two-dimensional code and so on, as system resources occupied a little area of the terminal 1, and when the program server 2 transmits the program source to the terminal 1, the terminal 1 only needs to add information with little data amount, such as generated program information, the preset two-dimensional code and so on, the program server 2 occupies little network resource, it is much more conducive to data transmit between the program server 2 and the terminal 1.

The exemplary embodiment displays the program information of each program and the preset two-dimensional code including the business information related to each program on the electronic program guide interface, so that user can only need to scan the preset two-dimensional code to acquire the business information related to each program, pushing the business information related to the program by the two-dimensional code on the electronic program guide interface is realized, rich and large amount of business information can be pushed to user through the two-dimensional code on the electronic program guide interface, user's requirement of acquiring much more relevant business information is met.

The serial numbers of the above exemplary embodiment of the present disclosure are only used for describing, not presenting the performances of the exemplary embodiments. Through the describing of the exemplary embodiments, the ordinary skill in the art can clearly know that the exemplary embodiment method can be achieved by software and a necessary general hardware platform, of course, by hardware, however in most cases, the former is a better exemplary embodiment. Based on the understanding, the technical proposal of the present disclosure essentially, or parts contributing to the existing technology, can be presented through software product, the computer software product is stored in a storage medium (such as ROM/RAM, a diskette, a light disk), includes a plurality of instructions which can be used for making a terminal device (the terminal device can be a phone, a computer, a server, an air conditioner, or a network device, and so on) to execute the methods of the exemplary embodiments of the present disclosure.

Above is only the preferred embodiments of the present disclosure, and the present disclosure is not limited to such embodiments. The present disclosure is intended to cover all modifications, equivalent replacements and improvements falling within the spirit and scope of the disclosure defined in the appended claims.

What is claimed is:

1. An information pushing method for an electronic program guide interface, comprising the following steps:
acquiring program information of each program comprised in a program source and a preset two-dimensional code corresponding to each program by a terminal, each preset two-dimensional code comprising business information related to each program;
generating an electronic program guide interface according to each program comprised in the program information and the corresponding preset two-dimensional code; and
when receiving an instruction for checking the electronic program guide interface, displaying the preset two-dimensional code corresponding to each program comprised in the program information on the electronic program guide interface by the terminal, for a user scanning the preset two-dimensional code to acquire the business information related to each program comprised in the program information.

2. The information pushing method for the electronic program guide interface according to claim 1, wherein acquiring program information of each program and a preset two-dimensional code corresponding to each program comprised in a program source by the terminal, the preset two-dimensional code comprising business information related to each program, comprises the following steps:
receiving a program transport stream sent by a program server by the terminal, the program transport stream comprises program information generated by the program server according to each program comprised in the program source, the preset two-dimensional code and relevant information recording a relationship between the program information and the preset two-dimensional codes, the preset two-dimensional codes comprises the business information related to each program;
analysing the program transport stream by the terminal to acquire the program information, the preset two-dimensional code and the relevant information, and acquiring the preset two-dimensional code corresponding to each program comprised in the program information according to the relevant information.

3. The information pushing method for the electronic program guide interface according to claim 1, wherein when receiving the instruction for checking the electronic program guide interface, displaying the preset two-dimensional code corresponding to each program comprised in the program information on the electronic program guide interface by the terminal, so that the user scanning the preset two-dimensional codes to acquire the business information related to each program comprised in the program information, comprises the following steps:
when receiving the instruction for checking the electronic program guide interface, displaying the preset two-dimensional code corresponding to each program comprised in the program information by the generated electronic program guide interface; or when receiving the instruction for checking the electronic program guide interface, displaying the preset two-dimensional code corresponding to each program comprised in the program information by a basic electronic program guide interface generated according to the program information.

4. The information pushing method for the electronic program guide interface according to claim 1, wherein the business information comprises a service content related to each program comprised in the program information and/or a chained address corresponding to the service content, after the terminal displaying the preset two-dimensional code corresponding to each program comprised in the program information on the electronic program guide interface when receiving the instruction for checking the electronic program guide interface, so that the user scanning the preset two-dimensional codes to acquire the business information related to each program comprised in the program information, the method further comprises the following steps:
analysing the preset two-dimensional code by the terminal to acquire the business information in the preset two-dimensional code related to each program;
if the business information comprised in the preset two-dimensional code related to each program is the service content, displaying the service content on the terminal;
if the business information comprised in the preset two-dimensional code related to each program is the chained address corresponding to the service content, acquiring corresponding service content through the chained address on a service server by the terminal, and displaying the service content on the terminal.

5. The information pushing method for the electronic program guide interface according to claim 2, wherein the business information comprises a service content related to each program comprised in the program information and/or a chained address corresponding to the service content, after the terminal displaying the preset two-dimensional code corresponding to each program comprised in the program information on the electronic program guide interface when receiving the instruction for checking the electronic program guide interface, so that the user scanning the preset two-dimensional codes to acquire the business information related to each program comprised in the program information, the method further comprises the following steps:
analysing the preset two-dimensional code by the terminal to acquire the business information in the preset two-dimensional code related to each program;
if the business information comprised in the preset two-dimensional code related to each program is the service content, displaying the service content on the terminal;
if the business information loaded in the preset two-dimensional code related to each program is the chained address corresponding to the service content, acquiring corresponding service content through the chained address on a service server by the terminal, and displaying the service content on the terminal.

6. The information pushing method for the electronic program guide interface according to claim 3, wherein the business information comprises a service content related to each program comprised in the program information and/or a chained address corresponding to the service content, after the terminal displaying the preset two-dimensional code corresponding to each program comprised in the program information on the electronic program guide interface when receiving the instruction for checking the electronic program guide interface, so that the user scanning the preset two-dimensional codes to acquire the business information related to each program comprised in the program information, the method further comprises the following steps:
analysing the preset two-dimensional code by the terminal to acquire the business information in the preset two-dimensional code related to each program;
if the business information comprised in the preset two-dimensional code related to each program is the service content, displaying the service content on the terminal;
if the business information comprised in the preset two-dimensional code related to each program is the chained address corresponding to the service content, acquiring corresponding service content through the chained address on a service server the terminal, and displaying the service content on the terminal.

7. The information pushing method for the electronic program guide interface according to claim 1, wherein when receiving the instruction for checking the electronic program guide interface, displaying the preset two-dimensional code corresponding to each program comprised in the program information on the electronic program guide interface by the terminal, so that the user scanning the preset two-dimensional code to acquire the business information related to each program comprised in the program information, comprises the following steps:
when receiving the instruction for checking the electronic program guide interface, displaying the preset two-dimensional code corresponding to each program on a preset area of the electrical program menu interface by the terminal, so that the user scanning the preset two-dimensional code to acquire the business information related to each program comprised in the program information.

8. An information pushing terminal for an electronic program guide interface, comprising:
an acquiring module, the acquiring module being used for acquiring program information comprising each program comprised in a program source and a preset two-dimensional code corresponding to each program, and the preset two-dimensional code comprising business information related to each program;
a generating module, the generating module being used for generating the electronic program guide interface according to each program comprised in the program information and the corresponding preset two-dimensional code;
a displaying module, the displaying module being used for displaying the preset two-dimensional code corresponding to each program comprised in the program information on the electronic program guide interface when receiving an instruction for checking the electronic program guide interface, so that a user scanning the preset two-dimensional code to acquire the business information related to each program comprised in the program information.

9. The information pushing terminal for the electronic program guide interface according to claim 8, wherein the acquiring module is also used for receiving a program transport stream sent by a program server, the program transport stream comprises program information generated by the program server according to each program comprised in the program source, the preset two-dimensional code and relevant information recording a relationship between each program and the preset two-dimensional code, the preset two-dimensional codes comprises the business information related to each program; the acquiring module is also used for analyzing the program transport stream to acquire the program information, the preset two-dimensional code and the relevant information, and acquire each program comprised in the program information and corresponding preset two-dimensional code according to the relevant information.

10. The information pushing terminal for the electronic program guide interface according to claim 8, wherein the displaying module is also used for displaying the preset two-dimensional code corresponding to each program comprised in the program information on the generated electric program interface when receiving the instruction for checking the electronic program guide interface; or when the instruction for checking the electronic program guide interface is received, the displaying module is also used for displaying the preset two-dimensional code corresponding to each program comprised in the program information on a basic electronic program guide interface generated according to the program information.

11. The information pushing terminal for the electronic program guide interface according to claim 8, wherein the business information comprises a service content related to each program comprised in the program information and/or a chained address corresponding to the service content, terminal further comprises:
an analyzing module, the analyzing module is used for analyzing the preset two-dimensional codes to acquire the business information in the preset two-dimensional codes related to each program; if the business information comprised in the preset two-dimensional codes related to each program is the service content, the service content is displayed on the terminal; if the business information comprised in the preset two-dimensional codes related to each program is the chained address corresponding to the service content, the analyzing module acquires corresponding service content by the chained address on a service server, and the service content is displayed on the terminal.

12. The information pushing terminal for the electronic program guide interface according to claim 9, wherein the business information comprises a service content related to each program comprised in the program information and/or a chained address corresponding to the service content, terminal further comprises:
an analyzing module, the analyzing module is used for analyzing the preset two-dimensional codes to acquire the business information in the preset two-dimensional codes related to each program; if the business information comprised in the preset two-dimensional codes related to each program is the service content, the service content is displayed on the terminal; if the business information comprised in the preset two-dimensional codes related to each program is the chained address corresponding to the service content, the analyzing module acquires corresponding service content by the chained address on a service server, and the service content is displayed on the terminal.

13. The information pushing terminal for the electronic program guide interface according to claim 10, wherein the business information comprises a service content related to each program comprised in the program information and/or a chained address corresponding to the service content, terminal further comprises:
an analyzing module, the analyzing module is used for analyzing the preset two-dimensional codes to acquire the business information in the preset two-dimensional codes related to each program; if the business information comprised in the preset two-dimensional codes related to each program is the service content, the service content is displayed on the terminal; if the business information comprised in the preset two-dimensional codes related to each program is the chained address corresponding to the service content, the analyzing module acquires corresponding service content by the chained address on a service server, and the service content is displayed on the terminal.

14. The information pushing terminal for the electronic program guide interface according to claim 8, wherein the displaying module is also used for displaying the preset two-dimensional code corresponding to each program on a preset area of the electrical program menu interface when receiving the instruction for checking the electronic program guide interface, so that the user scans the preset two-dimensional codes to acquire the business information related to each program comprised in the program information.

15. An information pushing system for an electronic program guide interface, comprising a terminal and a program server, wherein the program server generating program information and preset two-dimensional code according to each program comprised in a program source, the preset two-dimensional code comprising business information related to each program; the program information in the program source and the preset two-dimensional codes being sent to the terminal;
the terminal comprising:
an acquiring module, the acquiring module being used for the program information of each program comprised in the program source and the preset two-dimensional code corresponding to each program, the program information in the program source and the preset two-dimensional codes being sent to the terminal;
a generating module, the generating module being used for generating the electronic program guide interface according to each program comprised in the program information and the corresponding preset two-dimensional code; and
a displaying module, when receiving an instruction for checking the electronic program guide interface, the displaying module being used for displaying the preset two-dimensional code corresponding to each program comprised in the program information on the electronic program guide interface, so that a user scanning the preset two-dimensional code to acquire business information related to each program comprised in the program information.

16. The information pushing system for the electronic program guide interface according to claim 15, wherein the acquiring module is also used for receiving a program transport stream sent by a program server, the program transport stream comprises program information generated by the program server according to each program comprised in the program source, the preset two-dimensional code and relevant information recording a relationship between the program information and the preset two-dimensional codes, the preset two-dimensional codes comprises the business information related to each program; the terminal analyses the program transport stream to acquire the program information, the preset two-dimensional code and the relevant information, and acquires the preset two-dimensional code corresponding to each program comprised in the program information according to the relevant information.

17. The information pushing system for the electronic program guide interface according to claim 15, wherein the displaying module is also used for using the generated electronic program guide interface to display the preset two-dimensional code corresponding to each program comprised in the program information when receiving the instruction for checking the electronic program guide interface; or when receiving the instruction for checking the electronic program guide interface, the displaying module is also used for displaying preset two-dimensional code corresponding to each program comprised in the program information on a basic electronic program guide interface generated according to each program.

18. The information pushing method for the electronic program guide interface according to claim 15, wherein the business information comprises a service content related to each program comprised in the program information and/or a chained address corresponding to the service content, further comprises:
an analyzing module, the analyzing module is used for analyzing the preset two-dimensional codes to acquire the business information in the preset two-dimensional codes related to each program; if the business information comprised in the preset two-dimensional codes related to each program is the service content, the service content is displayed on the terminal; if the business information comprised in the preset two-dimensional codes related to each program is the chained address corresponding to the service content, the analyzing module acquires corresponding service content by the chained address on a service server, and the service content is displayed on the terminal.

19. The information pushing system for the electronic program guide interface according to claim 15, wherein the displaying module is also used for displaying the preset two-dimensional code corresponding to each program on a preset area of the electrical program menu interface when receiving the instruction for checking the electronic program guide interface, the terminal, so that the user scans the preset two-dimensional code to acquire the business information related to each program comprised in the program information.
